(19) United States
(12) Patent Application Publication
(10) Pub. No.: US 2026/0300198 A1
(43) Pub. Date: Oct. 1, 2026

(54) MEMORY CARD ACCESS CIRCUIT AND MEMORY CARD WRITING METHOD

(71) Applicant: SigmaStar Technology Ltd., Xiamen (CN)

(72) Inventors: Jing Guo, Xiamen (CN); Yan Qing Wang, Xiamen (CN); Yan Xiong Wu, Xiamen (CN)

(21) Appl. No.: 19/423,538

(22) Filed: Dec. 17, 2025

(30) Foreign Application Priority Data
Mar. 31, 2025 (CN) 202510390890.X

(51) Int. Cl. G06F 13/28

(52) U.S. Cl. CPC G06F 13/28; G06F 2213/28

(57) ABSTRACT

A memory card access circuit is coupled to a memory and is used to access a memory card. The memory card access circuit includes a direct memory access (DMA) circuit, an interface circuit, and a control circuit. The control circuit is coupled to the DMA circuit and the interface circuit, and is used to perform the following steps: (A) receiving a write command; (B) transmitting the write command to the memory card through the interface circuit; (C) receiving a status message from the memory card; and (D) controlling the DMA circuit to transmit to-be-written data to the memory card through the interface circuit after determining that the memory card can be written with data based on the status message.

This application claims the benefit of China application Serial No. 202510390890.X, filed on Mar. 31, 2025, the subject matter of which is incorporated herein by reference.

### BACKGROUND OF THE INVENTION

### 1. Field of the Invention

The present invention generally relates to a memory card, and more particularly, to a write operation of the memory card.

### 2. Description of Related Art

Memory cards (e.g., Secure Digital (SD) cards, Multimedia Cards (MMCs)) have wide applications, and the performance of memory cards is closely related to the write speed. Generally speaking, the write operation of a memory card is completed jointly by the memory card access circuit and the driver of the memory card access circuit. The shorter the pre-processing time of the memory card access circuit e.g. the time interval between receiving the response from the memory card (including, but not limited to, the check result) and starting to transmit the to-be-written data to the memory card, the higher the performance of the memory card. However, the memory card access circuit needs to communicate with its driver through an interrupt, and the transmission of to-be-written data is often not timely enough, which will increase the aforementioned pre-processing time. Therefore, it is necessary to provide a memory card access circuit and a memory card writing method to improve the performance of the memory card.

### SUMMARY OF THE INVENTION

In view of the issues of the prior art, an object of the present invention is to provide a memory card access circuit and a memory card writing method, so as to make an improvement to the prior art.

According to one aspect of the present invention, a memory card access circuit is provided. The memory card access circuit is coupled to a memory and configured to access a memory card. The memory card access circuit includes a direct memory access (DMA) circuit, an interface circuit, and a control circuit. The DMA circuit is coupled to the memory. The interface circuit is coupled to the DMA circuit and the memory card. The control circuit is coupled to the DMA circuit and the interface circuit and is configured to perform the following steps: (A) receiving a write command; (B) transmitting the write command to the memory card through the interface circuit; (C) receiving a status message from the memory card; and (D) after determining, based on the status message, that the memory card is in a writable state, controlling the DMA circuit to transmit to-be-written data to the memory card through the interface circuit.

According to another aspect of the present invention, a method of writing a memory card is provided. The method is applied to a memory card access circuit that includes a direct memory access (DMA) circuit and an interface circuit. The method includes the following steps: (A) receiving a write command; (B) transmitting the write command to the memory card through the interface circuit; (C) receiving a status message from the memory card; and (D) after determining, based on the status message, that the memory card is in a writable state, controlling the DMA circuit to transmit to-be-written data to the memory card through the interface circuit.

The technical means embodied in the embodiments of the present invention can solve at least one of the problems of the prior art. Therefore, compared to the prior art, the present invention can improve the performance of the memory card.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a functional block diagram of the electronic device according to an embodiment of the present invention.

FIG. 2A to FIG. 2B are flowcharts of the memory card writing method according to an embodiment of the present invention.

FIG. 3 is a functional block diagram of the electronic device according to another embodiment of the present invention.

FIG. 4 is the flowchart of the memory card writing method according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a memory card access circuit and a method of writing a memory card. On account of that some or all elements of the memory card access circuit could be known, the detail of such elements is omitted provided that such detail has little to do with the features of this disclosure, and that this omission nowhere dissatisfies the specification and enablement requirements. Some or all of the processes of the memory card writing method may be implemented by software and/or firmware and can be performed by the memory card access circuit or its equivalent. A person having ordinary skill in the art can choose components or steps equivalent to those described in this specification to carry out the present invention, which means that the scope of this invention is not limited to the embodiments in the specification.

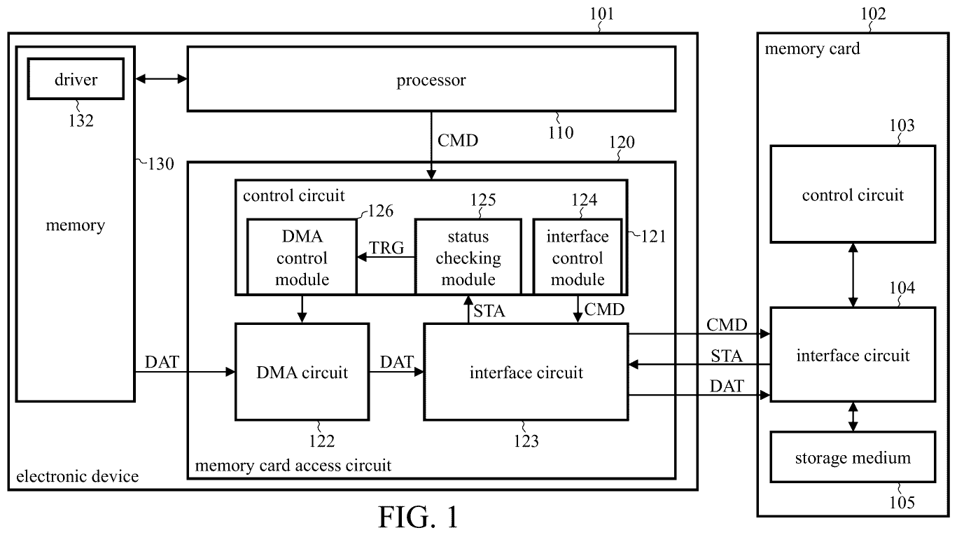

FIG. 1 is a functional block diagram of the electronic device according to an embodiment of the present invention. The electronic device 101 is coupled to the memory card 102, and includes the processor 110, the memory card access circuit 120, and the memory 130, all of which are coupled to one another. The memory 130 may be a Dynamic Random Access Memory (DRAM), and stores multiple program codes and/or program instructions. The electronic device 101 performs the write operation of the memory card 102 through the collaboration of the processor 110 and the memory card access circuit 120. More specifically, the processor 110 operates or drives the memory card access circuit 120 by executing a driver 132 of the memory card access circuit 120 (which is stored in the memory 130 in the form of program codes and/or program instructions).

The memory card 102 includes the control circuit 103, the interface circuit 104, and the storage medium 105, all of which are coupled to one another. The control circuit 103 controls the interface circuit 104 to receive and transmit data or commands. The storage medium 105 is a non-volatile memory (including, but not limited to, flash memory). In some embodiments, the memory card 102 is an SD card or an MMC card.

The memory card access circuit 120 includes the control circuit 121, the direct memory access (DMA) circuit 122, and the interface circuit 123, all of which are coupled to one another.

The control circuit 121 includes the interface control module 124, the status checking module 125, and the DMA control module 126.

The interface circuit 123 and the interface circuit 104 transmit commands or data through the physical layer or physical signals.

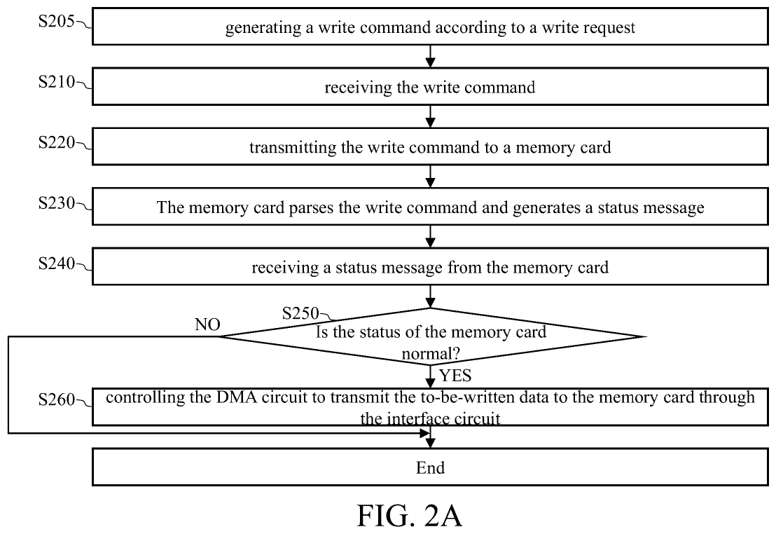

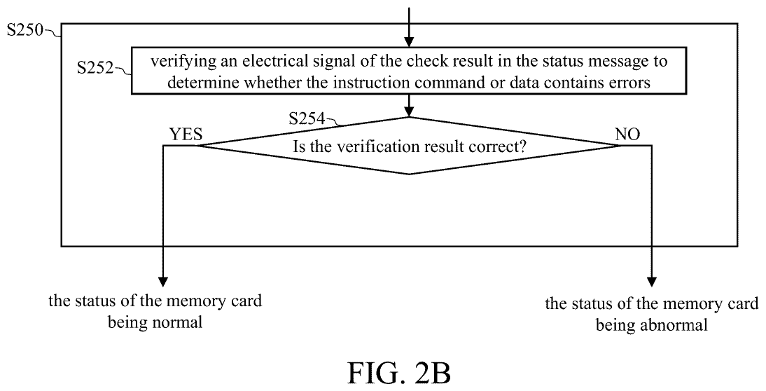

FIG. 2A to FIG. 2B are flowcharts of the memory card writing method according to an embodiment of the present invention. The memory card writing method includes the following steps.

Step S205: The processor 110 generates a write command CMD according to a write request. A write request may be generated by an application or an operating system executed by the processor 110. The processor 110 parses the message carried by the write request to extract information related to the write operation (including but not limited to): the length of the to-be-written data DAT, the source address (i.e., the address of the to-be-written data DAT in the memory 130), and the destination address (i.e., the address of the memory card 102). The processor 110 then generates the write command CMD based on the information, for example, generating the write command CMD by configuring the register(s).

Step S210: The memory card access circuit 120 receives the write command CMD.

Step S220: The memory card access circuit 120 transmits the write command CMD to the memory card 102. More specifically, the interface control module 124 of the control circuit 121 controls the interface circuit 123 to transmit the write command CMD to the memory card 102 (e.g., by notifying the control circuit 103 of the memory card 102 to read registers to obtain the write command CMD).

Step S230: The memory card 102 (more specifically, the control circuit 103) parses the write command CMD, and generates the status message STA according to the write command CMD. For example, the status message STA can indicate whether the block corresponding to the destination address in the storage medium 105 is normal. A block being normal means that data can be written to the block. For another example, the status message STA can include a check result (including, but not limited to, the result of a cyclic redundancy check (CRC)) generated by the control circuit 103 of the memory card 102 when it checks a command or data.

Step S240: The memory card access circuit 120 receives the status message STA from the memory card 102. More specifically, the status checking module 125 of the control circuit 121 receives a response from the memory card 102 (i.e., the status message STA) through the interface circuit 123.

Step S250: The memory card access circuit 120 determines whether the status of the memory card 102 is normal. More specifically, the status checking module 125 of the control circuit 121 determines whether the status of the memory card 102 is normal based on the status message STA. For example, the status of the memory card 102 being normal means that data can be written to the memory card 102 (i.e., the memory card 102 is in a writable state) and/or that the memory card 102 can correctly receive data or commands.

Reference is made to FIG. 2B, in some embodiments, step S250 includes the following sub-steps.

Step S252: The status checking module 125 verifies an electrical signal of the check result in the status message STA to determine whether the command or data contains an error. For example, the verification can be performed based on the CRC, and the status message of the check result can be stored in a related register.

Step S254: If the verification result is correct (Step S254 is YES), it indicates that the status of the memory card 102 is normal (i.e., step S250 is YES). If the verification result is incorrect (step S254 is NO), it indicates that the status of the memory card 102 is abnormal (i.e., step S250 is NO).

Step S260: The control circuit 121 controls the DMA circuit 122 to transmit the to-be-written data DAT through the interface circuit 123. More specifically, after the status checking module 125 confirms that the status of the memory card 102 is normal, the status checking module 125 generates a control signal TRG. In response to the control signal TRG, the DMA control module 126 controls the DMA circuit 122 to start reading the to-be-written data DAT from the memory 130 and then to transmit the to-be-written data DAT to the memory card 102 through the interface circuit 123 (the to-be-written data DAT is stored in the storage medium 105). The DMA circuit 122 continuously transmits the to-be-written data DAT until all the to-be-written data DAT is transmitted to the memory card 102.

In summary, after receiving the write command CMD generated by the processor 110, the memory card access circuit 120 can independently complete the subsequent operations without the involvement of the processor 110 (or the driver 132). That is to say, during the entire write operation process, the memory card access circuit 120 does not generate an interrupt. Compared to the conventional technology, this approach prevents the processor 110 from handling interrupts (interrupt handling is usually relatively time-consuming and resource-intensive), greatly reducing the pre-processing time of the write operation.

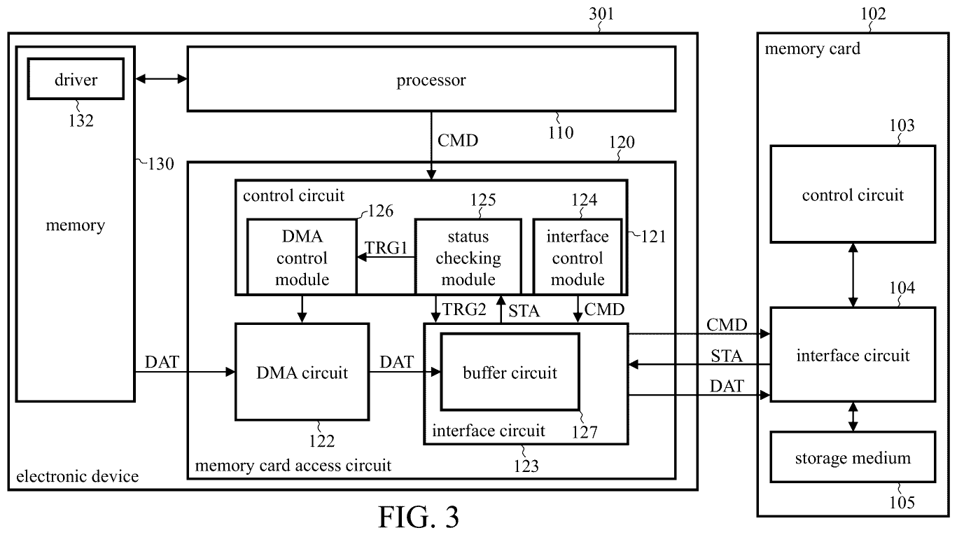

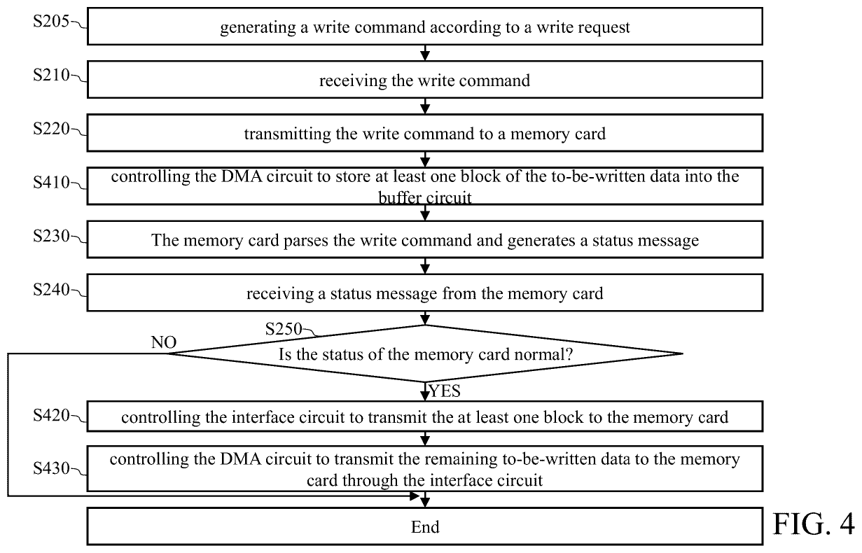

FIG. 3 is a functional block diagram of the electronic device according to another embodiment of the present invention. The electronic device 301 is similar to the electronic device 101, except that the interface circuit 123 includes the buffer circuit 127 (e.g., a Static Random Access Memory (SRAM)), and the control circuit 121 (more specifically, the status checking module 125) has the function of pre-reading the to-be-written data DAT (which will be discussed in detail below with reference to FIG. 4). This function can reduce the pre-processing time of a write operation.

FIG. 4 is the flowchart of the memory card writing method according to another embodiment of the present invention. The memory card writing method includes steps S205 to S250 and steps S410 to S430, wherein steps S205 to S250 are the same as those in FIG. 2A.

In the embodiment of FIG. 4, after the completion of step S220, the status checking module 125 controls the DMA control module 126 to pre-read at least one block of the to-be-written data DAT (e.g., the first block of the to-be-written data DAT) from the memory 130 and store the at least one block into the buffer circuit 127 of the interface circuit 123 (step S410). Step S410 corresponds to the above-mentioned function of pre-reading the to-be-written data DAT.

It should be noted that, in some embodiments, step S410 can be performed before step S220, or even the two can be performed at substantially the same time (e.g., the two steps overlap at least partially in time). That is to say, the memory card access circuit 120 (more specifically, the status checking module 125) can, at the earliest, immediately after receiving the write command CMD (step S210), use the control signal TRG1 to control the DMA control module 126 to transmit at least one block of the to-be-written data DAT through the DMA circuit 122.

After confirming that the status of the memory card 102 is normal (step S250 is YES), the control circuit 121 (more specifically, the status checking module 125) issues the control signal TRG2 to control the interface circuit 123 to transmit the at least one block to the memory card 102 (step S420), and transmits the control signal TRG1 to the DMA control module 126.

In response to the control signal TRG1, the DMA control module 126 controls the DMA circuit 122 to transmit the remaining to-be-written data DAT (i.e., the part of the to-be-written data DAT excluding the at least one block) through the interface circuit 123 (step S430).

In summary, because the memory card access circuit 120 reads a part of the to-be-written data DAT in advance (e.g., before receiving the response from the memory card 102 (step S240)) and stores it in the buffer circuit 127 (step S410), the transmission of the to-be-written data DAT becomes faster and more timely, significantly reducing the pre-processing time of the memory card access circuit 120 between receiving the response from the memory card and starting to transmit the to-be-written data DAT.

In some embodiments, the memory card access circuit 120 may be an application specific integrated circuit (ASIC) or implemented by a circuit or hardware, such as a programmable logic device (PLD).

Various functional components or blocks have been described herein. As appreciated by persons skilled in the art, in some embodiments, the functional blocks can preferably be implemented through circuits (either dedicated circuits, or general purpose circuits, which operate under the control of one or more processors and coded instructions), which typically comprise transistors or other circuit elements that are configured in such a way as to control the operation of the circuitry in accordance with the functions and operations described herein. As further appreciated by persons skilled in the art, the specific structure or interconnections of the circuit elements can typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A memory card access circuit, coupled to a memory and used to access a memory card, the memory card access circuit comprising:
a direct memory access (DMA) circuit coupled to the memory;
an interface circuit coupled to the DMA circuit and the memory card; and
a control circuit coupled to the DMA circuit and the interface circuit and configured to perform following steps:
(A) receiving a write command;
(B) transmitting the write command to the memory card through the interface circuit;
(C) receiving a status message from the memory card; and
(D) after determining that the memory card is in a writable state based on the status message, controlling the DMA circuit to transmit to-be-written data to the memory card through the interface circuit.

2. The memory card access circuit of claim 1, wherein the memory stores a driver of the memory card access circuit, the memory card access circuit is coupled to a processor, the processor executes the driver to control the memory card access circuit, and no interrupt is transmitted from the memory card access circuit to the processor during steps (A) to (D).

3. The memory card access circuit of claim 1, wherein the interface circuit comprises a buffer circuit, and the control circuit further executes following steps after step (A):
(E) controlling the DMA circuit to store at least one block of the to-be-written data to the buffer circuit; and
(F) controlling the interface circuit to transmit the at least one block to the memory card.

4. The memory card access circuit of claim 3, wherein step (E) is between step (A) and step (B).

5. The memory card access circuit of claim 3, wherein step (E) is between step (B) and step (C).

6. The memory card access circuit of claim 3, wherein step (E) and step (B) are performed substantially simultaneously.

7. The memory card access circuit of claim 3, wherein the memory stores a driver of the memory card access circuit, the memory card access circuit is coupled to a processor, the processor executes the driver to control the memory card access circuit, and no interrupt is transmitted from the memory card access circuit to the processor during steps (A) to (D).

8. The memory card access circuit of claim 3, wherein the status message comprises a check result, and step (D) comprises:
(D1) verifying an electrical signal of the check result in the status message.

9. A method of writing a memory card applied to a memory card access circuit comprising a direct memory access (DMA) circuit and an interface circuit, the method comprising:
(A) receiving a write command;
(B) transmitting the write command to the memory card through the interface circuit;
(C) receiving a status message from the memory card; and
(D) after determining that the memory card is in a writable state based on the status message, controlling the DMA circuit to transmit to-be-written data to the memory card through the interface circuit.

10. The method of claim 9, wherein the interface circuit comprises a buffer circuit, and the method further comprises performing following steps after step (A):
(E) controlling the DMA circuit to store at least one block of the to-be-written data to the buffer circuit; and
(F) controlling the interface circuit to transmit the at least one block to the memory card.
